(19) United States
(12) Patent Application Publication
(10) Pub. No.: US 2021/0408639 A1
(43) Pub. Date: Dec. 30, 2021

(54) COMPOSITION

(71) Applicant: Sumitomo Chemical Company, Limited, Tokyo (JP)

(72) Inventors: Kensaku HORIE, Niihama City (JP); Hiroki HASHIWAKI, Niihama City (JP); Eri HAYASHI, Niihama City (JP)

(21) Appl. No.: 17/362,128

(22) Filed: Jun. 29, 2021

(30) Foreign Application Priority Data
Jun. 30, 2020 (JP) 2020-113260
Jun. 23, 2021 (JP) 2021-104361

(51) Int. Cl. H01M 50/449; H01M 50/403; H01M 50/417; H01M 50/491; H01M 10/0525

(52) U.S. Cl. CPC H01M 50/449; H01M 50/403; H01M 10/0525; H01M 50/491; H01M 50/417

(57) ABSTRACT

A composition which makes it possible to easily find defects of a nonaqueous electrolyte secondary battery laminated separator is provided. The composition includes a solvent and an aramid resin in which (i) each of aromatic rings in a main chain has an electron-withdrawing group, (ii) at least one end of a molecule is an amino group, and (iii) more than 90% of bonds with which the aromatic rings in the main chain are connected to each other are amide bonds.

This Nonprovisional application claims priority under 35 U.S.C. § 119 on Patent Application No. 2020-113260 filed in Japan on Jun. 30, 2020 and Patent Application No. 2021-filed in Japan on Jun. 23, 2021, the entire contents of which are hereby incorporated by reference.

### TECHNICAL FIELD

The present invention relates to a composition which can be used in production of a laminated separator for a nonaqueous electrolyte secondary battery (hereinafter referred to as a “nonaqueous electrolyte secondary battery laminated separator”).

### BACKGROUND ART

Nonaqueous electrolyte secondary batteries, particularly lithium ion secondary batteries, have a high energy density and are therefore in wide use as batteries for personal computers, mobile phones, portable information terminals, and the like. Such nonaqueous electrolyte secondary batteries are recently being developed as on-vehicle batteries.

A nonaqueous electrolyte secondary battery laminated separator which is used as a member of a nonaqueous electrolyte secondary battery is typically produced by coating a polyolefin porous film which serves as a base material with a coating solution which contains a binder resin, a filler, and the like to form a porous layer on one surface or both surfaces of the base material.

It is known that any of various resins such as a (meth)acrylate resin, a fluorine-containing resin, a polyamide-based resin, and a polyimide-based resin can be used as the binder resin. For example, Patent Literature 1 discloses a nonaqueous electrolyte secondary battery separator which has a lamination structure constituted by a certain wholly aromatic polyamide porous film and a porous film having a shutdown function.

### CITATION LIST

### Patent Literature

[Patent Literature 1]

Japanese Patent Application Publication Tokukai No. 2003-40999 (Publication date: Feb. 13, 2003)

### SUMMARY OF INVENTION

### Technical Problem

A conventional coating solution is transparent or is merely slightly colored. Therefore, after a base material is coated with such a coating solution, it is difficult to find defects such as foreign substances, uneven coating, gas bubbles, dirt, and pin holes which would occur on the nonaqueous electrolyte secondary battery laminated separator. The same applies to the nonaqueous electrolyte secondary battery separator disclosed in Patent Literature 1.

Meanwhile, a nonaqueous electrolyte secondary battery laminated separator is a member that is used inside a nonaqueous electrolyte secondary battery. Therefore, adding some sort of coloring component to the coating solution is not preferable because such addition of the coloring component may adversely affect performance of the nonaqueous electrolyte secondary battery laminated separator, and even performance of the nonaqueous electrolyte secondary battery.

Under the circumstances, a technique has been demanded which enables easy finding of the defects without adding a coloring component to a coating solution which is used for forming a porous layer.

In view of this, an objective of an aspect of the present invention is to provide a composition which makes it possible to easily find defects of a nonaqueous electrolyte secondary battery laminated separator.

### Solution to Problem

The present invention has aspects described in [1] through [10] below.

[1] A composition including a solvent and an aramid resin in which (i) each of aromatic rings in a main chain has an electron-withdrawing group, (ii) at least one end of a molecule is an amino group, and (iii) more than 90% of bonds with which the aromatic rings in the main chain are connected to each other are amide bonds.

[2] The composition described in [1], in which, in the aramid resin, (iv) 25% or more of aromatic diamine-derived units have electron-withdrawing groups, and (v) 50% or less of acid chloride-derived units have electron-withdrawing groups.

[3] The composition described in [1] or [2], in which the electron-withdrawing group is one or more groups selected from the group consisting of halogen, a cyano group, and a nitro group.

[4] The composition described in any of [1] through [3], in which the aramid resin has an intrinsic viscosity of 0.5 dL/g to 4.0 dL/g.

[5] The composition described in any of [1] through [4], further including a filler.

[6] The composition described in any of [1] through [5], which has a total-light transmittance of 5% or less, the total-light transmittance being measured in conformity to JIS K7361-1: 1997 in a quartz cell having an optical path length of 5 mm.

[7] A laminated body, in which the composition described in any of [1] through [6] is formed on one surface or both surfaces of a polyolefin porous film.

[8] A method for producing a nonaqueous electrolyte secondary battery laminated separator, including the steps of: forming a composition described in any of [1] through [6] on one surface or both surfaces of a polyolefin porous film; and removing 99% or more of the solvent from the composition.

[9] A nonaqueous electrolyte secondary battery laminated separator, including: a polyolefin porous film; and a porous layer which is constituted by a binder resin and a filler and is formed on the polyolefin porous film, the nonaqueous electrolyte secondary battery laminated separator having a total-light transmittance of 30% or less, the total-light transmittance being measured in conformity to JIS K7361-1: 1997.

[10] The nonaqueous electrolyte secondary battery laminated separator described in [9], in which: the binder resin is an aramid resin in which (i) each of aromatic rings in a main chain has an electron-withdrawing group, (ii) at least one end of a molecule is an amino group, and (iii) more than 90% of bonds with which the aromatic rings in the main chain are connected to each other are amide bonds.

### Advantageous Effects of Invention

According to an aspect of the present invention, it is possible to easily find defects of a nonaqueous electrolyte secondary battery laminated separator.

### BRIEF DESCRIPTION OF DRAWINGS

FIG. 1 is a diagram showing total-light transmittances of compositions prepared in Examples and Comparative Examples.

FIG. 2 is a diagram showing total-light transmittances of nonaqueous electrolyte secondary battery laminated separators prepared in Examples and Comparative Examples.

FIG. 3 is a diagram showing a color difference between a defective part and a normal part of each of nonaqueous electrolyte secondary battery laminated separators prepared in Examples and Comparative Examples.

### DESCRIPTION OF EMBODIMENTS

The following description will discuss embodiments of the present invention. The present invention is, however, not limited to the embodiments below. The present invention is not limited to arrangements described below, but may be altered in various ways by a skilled person within the scope of the claims. The present invention also encompasses, in its technical scope, any embodiment derived by appropriately combining technical means disclosed in differing embodiments. Note that a numerical range “A to B” herein means “A or more (higher) and B or less (lower)” unless otherwise stated.

### Embodiment 1: Composition

The composition in accordance with an embodiment of the present invention includes a solvent and an aramid resin in which (i) each of aromatic rings in a main chain has an electron-withdrawing group, (ii) at least one end of a molecule is an amino group, and (iii) more than 90% of bonds with which the aromatic rings in the main chain are connected to each other are amide bonds.

According to the configuration, the aramid resin satisfies the above conditions (i) through (iii), and this makes it possible to obtain a composition having a low total-light transmittance without adding a coloring component or the like as shown in Examples described later.

As a result, it is possible to keep down a total-light transmittance of a nonaqueous electrolyte secondary battery laminated separator which includes a porous layer that has been obtained by forming the composition on a polyolefin porous film. This makes it possible to easily detect presence or absence of defects of the nonaqueous electrolyte secondary battery laminated separator.

A main chain of the aramid resin has, for example, a structure indicated in parentheses of a chemical formula below. Note that, in the chemical formula below, bonds with which aromatic rings included in the main chain are connected to each other are only amide bonds. However, the embodiment of the present invention is not necessarily limited to this, provided that more that 90% of the bonds are amide bonds. Such other bonds can be an ether bond, a sulfonyl bond, and the like.

A proportion of the amide bonds occupying the bonds is more preferably 95% or more, and most preferably 100%. The aramid resin preferably has no ether bond as the bonds with which the aromatic rings in the main chain are connected to each other.

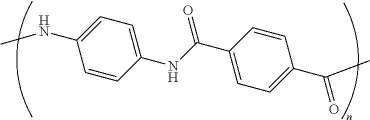

Examples of the electron-withdrawing group include halogen, —CN, —NO₂, —⁺NH₃, —CF₃, —CCl₃, —CHO, —COCH₃, —CO₂C₂H₅, —CO₂H, —SO₂CH₃, —SO₃H, —OCH₃, and the like. The electron-withdrawing group can be one type or can be two or more types.

Among those, from the viewpoint of prices, the electron-withdrawing group is preferably one or more groups selected from the group consisting of halogen, a cyano group, and a nitro group, which are generally distributed.

Both ends or at least one end of the molecule of the aramid resin is an amino group. That is, at least one of aromatic rings at ends of the molecule has an amino group. According to the aramid resin having the amino group at the end, the amino group and the aromatic ring part function as a chromophore, and this makes it possible to enhance coloring of a polymer.

The aramid resin satisfying the above conditions (i) through (iii) can be produced by causing an aromatic diamine to react with an aromatic carboxylic acid in a solvent.

It is preferable, in the aramid resin, that (iv) 25% or more of aromatic diamine-derived units have electron-withdrawing groups, and (v) 50% or less of acid chloride-derived units have electron-withdrawing groups.

The term “aromatic diamine-derived unit” refers to a structural unit represented by —(NH—Ar—NH)—. This structural unit also includes NH₂—Ar—NH— and —NH—Ar—NH₂, which are structural units in which an end thereof is an amino group. The feature “25% or more of the units have electron-withdrawing groups” means that 25% or more of aromatic rings (Ar) in the units present within the molecule of the aramid resin have electron-withdrawing groups.

A ratio at which the aromatic diamine-derived units have the electron-withdrawing groups is more preferably 50% or more, more preferably 75% or more, and most preferably 100%.

The term “acid chloride-derived unit” refers to a structural unit represented by —(CO—Ar—CO)—. The feature “50% or less of the units have electron-withdrawing groups” means that 50% or less of aromatic rings (Ar) in the units present within the molecule of the aramid resin have electron-withdrawing groups. A ratio at which the acid chloride-derived units have the electron-withdrawing groups is preferably as low as possible, more preferably 25% or less, further preferably 10% or less, and most preferably 0%.

The aramid resin satisfying the above conditions (iv) and (v) makes it possible to easily obtain the composition having a lower total-light transmittance.

From the viewpoint of improving heat resistance of the porous layer, the intrinsic viscosity of the aramid resin is preferably 0.5 dL/g to 4.0 dL/g. The intrinsic viscosity can be confirmed, for example, by a method disclosed in WO2016/002785. That is, 0.5 g of an aramid resin is dissolved in 100 mL of concentrated sulfuric acid, and the intrinsic viscosity is measured using a capillary viscometer. The intrinsic viscosity can be controlled by adjusting a contained amount of the monomer.

The aramid resin includes aromatic polyamide, wholly aromatic polyamide, and the like. The aromatic polyamide is preferably one or more resins selected from the group consisting of para(p)-aromatic polyamide and meth(m)-aromatic polyamide.

Specific examples of the aramid resins include one or more selected from poly(paraphenylene terephthalamide), poly(metaphenylene isophthalamide), poly(metaphenylene terephthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/metaphenylene terephthalamide copolymer, a paraphenylene terephthalamide/2,6-dichloroparaphenylene terephthalamide copolymer, and a metaphenylene terephthalamide/2,6-dichloroparaphenylene terephthalamide copolymer.

Among these, poly(paraphenylene terephthalamide), poly(metaphenylene terephthalamide), and the paraphenylene terephthalamide/metaphenylene terephthalamide copolymer are preferable.

The solvent contained in the composition in accordance with an embodiment of the present invention is preferably a solvent that does not adversely affect the base material, that allows the aramid resin to be dissolved or dispersed therein uniformly and stably, and that allows the filler to be dispersed therein uniformly and stably.

Examples of the solvent include a nonpolar solvent disclosed in WO2016/002785. Specifically, the solvent can be N-methylpyrrolidone, N,N-dimethylacetamide, N,N-dimethylformamide, or the like. Each of these solvents can be used solely. Alternatively, two or more of these solvents can be used in combination.

The composition in accordance with an embodiment of the present invention preferably further includes a filler. The filler is preferably a heat-resistant filler. The heat-resistant filler can be an inorganic filler or an organic filler, and the composition preferably contains an inorganic filler. The heat-resistant filler refers to a filler having a melting point of not lower than 150° C.

From the viewpoint of improving heat resistance of the porous layer, a content of the filler in the composition is preferably not less than 40% by weight and not more than 70% by weight, where a weight of a solid content of the composition is 100% by weight. The content is more preferably not less than 50% by weight and less than 70% by weight.

As the filler, it is possible to employ, for example, one or more inorganic fillers selected from inorganic substances such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass.

Among those, the filler is preferably a metal oxide filler, from the viewpoint of improving heat resistance of the porous layer. The term “metal oxide filler” indicates an inorganic filler composed of metal oxide. The metal oxide filler can be, for example, an inorganic filler made of an aluminum oxide and/or a magnesium oxide.

Examples of organic substances constituting the organic filler include one or more selected from (i) a homopolymer of a monomer such as styrene, vinyl ketone, acrylonitrile, methyl methacrylate, ethyl methacrylate, glycidyl methacrylate, glycidyl acrylate, or methyl acrylate, or (ii) a copolymer of two or more of such monomers; fluorine-containing resins such as polytetrafluoroethylene, an tetrafluoroethylene/hexafluoropropylene copolymer, a tetrafluoroethylene/ethylene copolymer, and polyvinylidene fluoride; a melamine resin; a urea resin; polyethylene; polypropylene; polyacrylic acid and polymethacrylic acid; a resorcinol resin; and the like.

An average particle diameter (D50) of the filler is preferably 0.001 μm or more and 10 μm or less, more preferably 0.01 μm or more and 8 μm or less, further preferably 0.05 μm or more and 5 μm or less. The average particle diameter of the filler is a value measured with use of MICROTRAC (MODEL: MT-3300EXII) available from NIKKISO CO., LTD.

A shape of the filler varies depending on a method for producing a raw material, i.e., an organic substance or an inorganic substance, a dispersion condition of the filler in preparing a coating liquid for forming the porous layer, and the like. Accordingly, the shape of the filler can be any of various shapes including (i) a shape such as a spherical shape, an oval shape, a rectangular shape, a gourd-like shape and (ii) an indefinite shape having no specific shape.

The composition in accordance with an embodiment of the present invention preferably has a total-light transmittance of 5% or less, the total-light transmittance being measured in conformity to JIS K7361-1: 1997 in a quartz cell having an optical path length of 5 mm.

According to the configuration, the total-light transmittance is sufficiently low, and therefore a total-light transmittance of the porous layer which is formed with use of the composition becomes sufficiently low. This makes it possible to provide the nonaqueous electrolyte secondary battery laminated separator which enables easy detection of defects.

The total-light transmittance is more preferably 3% or less, further preferably 1.5% or less, particularly preferably 0.5% or less.

The measuring device can be a measuring device described in JIS K7361-1: 1997. That is, the measuring device only needs to include: a stabilized light source, an optical system and a photometer which are combined with the light source; and an integrating sphere which has an opening and into which no external luminous flux enters. As the light source, a C illuminant is used. For example, it is possible to use COH-7700 available from NIPPON DENSHOKU INDUSTRIES CO., LTD.

JIS K7361-1: 1997 defines a total-light transmittance test method in a visible region of a flat, transparent, and basically colorless plastic. In the test, a test piece is placed directly on an integrating sphere. In contrast, since the composition in accordance with an embodiment of the present invention contains a solvent and an aramid resin, a total-light transmittance of the composition is measured in a quartz cell having an optical path length of 5 mm. Except for this, the total-light transmittance is measured on the basis of the method defined by JIS K7361-1: 1997. An obtained value is the foregoing total-light transmittance.

The composition in accordance with an embodiment of the present invention can be obtained by mixing the solvent, the aramid resin, and, optionally, the filler. When the filler is employed, from the viewpoint of improving heat resistance of the porous layer, a content of the filler is preferably 40% by weight to 70% by weight, more preferably 50% by weight to 70% by weight, where a weight of the aramid resin and the filler is 100% by weight.

The following description will discuss other embodiments of the present invention. For convenience of explanation, the matters described in Embodiment 1 will not be repeatedly described.

### Embodiment 2: Laminated Body

In a laminated body in accordance with an embodiment of the present invention, the composition in accordance with an embodiment of the present invention is formed on one surface or both surfaces of a polyolefin porous film. By removing the solvent contained in the composition, the composition forms a porous layer, and thus a nonaqueous electrolyte secondary battery laminated separator can be obtained. That is, the laminated body is a semifinished product of the nonaqueous electrolyte secondary battery laminated separator.

As described in Embodiment 1, the composition has a low total-light transmittance. Therefore, the laminated body makes it possible to provide the nonaqueous electrolyte secondary battery laminated separator which enables easy detection of defects.

The polyolefin porous film (hereinafter sometimes simply referred to as “porous film”) contains polyolefin as a main component and has a large number of pores connected to one another, and allows a gas and a liquid to pass therethrough from one surface to the other. The porous film serves as a base material on which the porous layer is formed in the laminated body. The porous layer has a structure in which many pores, connected to one another, are provided, so that the porous layer is a layer through which a gas or a liquid can pass from one surface to the other.

The porous film contains a polyolefin at a proportion of not less than 50% by volume, preferably not less than 90% by volume, more preferably not less than 95% by volume, relative to the entire porous film.

The polyolefin more preferably contains a high molecular weight component having a weight-average molecular weight of 5×10⁵ to 15×10⁶. In particular, the polyolefin more preferably contains a high molecular weight component having a weight-average molecular weight of not less than 1,000,000 because such a polyolefin allows the laminated body to have higher strength.

Examples of the polyolefin include a homopolymer or a copolymer each produced by polymerizing monomers such as ethylene, propylene, 1-butene, 4-methyl-1-pentene, or 1-hexene. Examples of the homopolymer include polyethylene, polypropylene, and polybutene. Examples of the copolymer include an ethylene/propylene copolymer.

Among the above examples, polyethylene is more preferable as it is capable of preventing a flow of an excessively large electric current at a lower temperature. Examples of the polyethylene include low-density polyethylene, high-density polyethylene, linear polyethylene (ethylene/α-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is further preferable.

The porous film has a film thickness of preferably 4 μm to 40 μm, more preferably 5 μm to 30 μm, still more preferably 6 μm to 15 μm.

The porous film can have a weight per unit area which weight is appropriately determined in view of the strength, film thickness, weight, and handleability. The weight per unit area is, however, within a range of preferably 4 g/m² to 15 g/m², more preferably 4 g/m² to 12 g/m², even more preferably 5 g/m² to 10 g/m², so as to allow a nonaqueous electrolyte secondary battery to have a higher weight energy density and a higher volume energy density.

The porous film has an air permeability of preferably 30 sec/100 mL to 500 sec/100 mL, more preferably 50 sec/100 mL to 300 sec/100 mL, in terms of Gurley values. A porous film having an air permeability within the above range can have sufficient ion permeability.

The nonaqueous electrolyte secondary battery laminated separator including the porous layer obtained by forming the composition in accordance with an embodiment of the present invention on the porous film has an air permeability of preferably 30 sec/100 mL to 1000 sec/100 mL, more preferably 50 sec/100 mL to 800 sec/100 mL, in terms of Gurley values. The nonaqueous electrolyte secondary battery laminated separator, which has the above air permeability, allows the nonaqueous electrolyte secondary battery to have sufficient ion permeability.

The porous film has a porosity of preferably 20% by volume to 80% by volume, more preferably 30% by volume to 75% by volume, so as to (i) retain a larger amount of electrolyte and (ii) reliably prevent a flow of an excessively large electric current at a lower temperature. Further, in order to obtain sufficient ion permeability and prevent particles from entering the positive electrode and/or the negative electrode, the porous film has pores each having a pore diameter of preferably not larger than 0.30 μm, more preferably not larger than 0.14 μm, even more preferably not larger than 0.10 μm.

The method for producing the polyolefin porous film is not limited to any particular one. For example, the method can include the following steps:

(A) Obtaining a polyolefin resin composition by kneading ultra-high molecular weight polyethylene, low molecular weight polyethylene having a weight-average molecular weight of not more than 10,000, a pore forming agent (such as calcium carbonate or plasticizer), and an antioxidant;

(B) Forming a sheet by rolling the obtained polyolefin resin composition with use of a pair of rollers, and gradually cooling the polyolefin resin composition while pulling the polyolefin resin composition with use of a winding roller rotating at a rate different from that of the pair of rollers;

(C) Removing the pore forming agent from the obtained sheet with use of an appropriate solvent; and

(D) Stretching, at an appropriate stretch magnification, the sheet from which the pore forming agent has been removed.

The composition can be formed on one surface or both surfaces of the polyolefin porous film by, for example, a gravure coater method, a dip coater method, a bar coater method, or a die coater method.

### Embodiment 3: Method for Producing Nonaqueous Electrolyte Secondary Battery Laminated Separator

The method for producing a nonaqueous electrolyte secondary battery laminated separator in accordance with an embodiment of the present invention includes the steps of: forming the composition in accordance with an embodiment of the present invention on one surface or both surfaces of a polyolefin porous film; and removing 99% or more of the solvent from the composition.

The step of forming the composition on the polyolefin porous film can be carried out with a gravure coater method or the like, as described in Embodiment 2. The step of removing 99% or more of the solvent from the composition can by carried out by a method in which the solvent is removed by being dried. A fact that 99% or more of the solvent has been removed can be confirmed by thermogravimetric analysis (TGA).

With the above steps, a porous layer is formed on one surface or both surfaces of a porous film (base material) from the composition. Thus, the nonaqueous electrolyte secondary battery laminated separator is obtained.

Removal of the solvent can also be carried out, for example, by the following method.

(1) Coating one surface or both surfaces of a base material with the composition, and then immersing the base material into a deposition solvent (which is a poor solvent for the aramid resin) for deposition of the aramid resin to form a porous layer, and then drying the porous layer to remove the solvent.

(2) Coating one surface or both surfaces of a base material with the composition, and then depositing the aramid resin with use of a low-boiling-point solvent to form a porous layer, and then drying the porous layer to remove the solvent.

As the deposition solvent, for example, water, ethyl alcohol, isopropyl alcohol, acetone, or the like can be used.

### Embodiment 4: Nonaqueous Electrolyte Secondary Battery Laminated Separator

A nonaqueous electrolyte secondary battery laminated separator in accordance with an embodiment of the present invention includes: a polyolefin porous film; and a porous layer which is constituted by a binder resin and a filler and is formed on the polyolefin porous film, the nonaqueous electrolyte secondary battery laminated separator having a total-light transmittance of 30% or less, the total-light transmittance being measured in conformity to JIS K7361-1: 1997.

In the nonaqueous electrolyte secondary battery laminated separator in accordance with an embodiment of the present invention, the binder resin is an aramid resin in which: (i) each of aromatic rings in a main chain has an electron-withdrawing group, (ii) at least one end of a molecule is an amino group, and (iii) more than 90% of bonds with which the aromatic rings in the main chain are connected to each other are amide bonds.

### Embodiment 5: Nonaqueous Electrolyte Secondary Battery Member and Nonaqueous Electrolyte Secondary Battery

The nonaqueous electrolyte secondary battery member in accordance with an embodiment of the present invention includes a positive electrode, the above nonaqueous electrolyte secondary battery laminated separator, and a negative electrode which are arranged in this order. A nonaqueous electrolyte secondary battery in accordance with an embodiment of the present invention includes the above nonaqueous electrolyte secondary battery laminated separator. The nonaqueous electrolyte secondary battery typically has a structure in which the negative electrode and the positive electrode face each other through the nonaqueous electrolyte secondary battery laminated separator. In the nonaqueous electrolyte secondary battery, a battery element in which the above structure is impregnated with an electrolyte is enclosed in an exterior member. The nonaqueous electrolyte secondary battery is, for example, a lithium-ion secondary battery that achieves electromotive force through doping with and dedoping of lithium ions.

<Positive Electrode>

Examples of the positive electrode include a positive electrode sheet having a structure in which an active material layer containing a positive electrode active material and a binding agent is formed on a current collector. The active material layer may further contain an electrically conductive agent.

The positive electrode active material is, for example, a material capable of being doped with and dedoped of lithium ions.

Examples of such a material include a lithium complex oxide containing at least one transition metal such as V, Ti, Cr, Mn, Fe, Co, Ni, or Cu. Example of the lithium complex oxide include a lithium complex oxide having a layer structure, a lithium complex oxide having a spinel structure, and a solid solution lithium-containing transition metal oxide constituted by a lithium complex oxide having both a layer structure and a spinel structure. Moreover, examples of the lithium complex oxide also include a lithium-cobalt complex oxide and a lithium-nickel complex oxide. Furthermore, examples of the lithium complex oxide also include lithium complex oxides in which one or some of transition metal atoms mainly constituting the above lithium complex oxides are substituted with other elements such as Na, K, B, F, Al, Ti, V, Cr, Mn, Fe, Co, Ni, Cu, Zn, Mg, Ca, Ga, Zr, Si, Nb, Mo, Sn and W.

Examples of the lithium complex oxide in which one or some of transition metal atoms mainly constituting the above lithium complex oxides are substituted with other elements include a lithium-cobalt complex oxide having a layer structure represented by a formula (2) below, a lithium-nickel complex oxide represented by a formula (3) below, a lithium-manganese complex oxide having a spinel structure represented by a formula (4) below, a solid solution lithium-containing transition metal oxide represented by a formula (5) below, and the like.

Li[Liₓ(Co₁₋ₐM¹ₐ)₁₋ₓ]O₂ (2)

(in the formula (2), M1 is at least one metal selected from the group consisting of Na, K, B, F, Al, Ti, V, Cr, Mn, Fe, Ni, Cu, Zn, Mg, Ga, Zr, Si, Nb, Mo, Sn and W, and −0.1≤x≤0.30 and 0≤a≤0.5 are satisfied)

Li[Li_{y}(Ni_{1-b}M²_{b})_{1-y}]O₂ (3)

(in the formula (3), M² is at least one metal selected from the group consisting of Na, K, B, F, Al, Ti, V, Cr, Mn, Fe, Co, Cu, Zn, Mg, Ga, Zr, Si, Nb, Mo, Sn and W, and −0.1≤y≤0.30 and 0≤b≤0.5 are satisfied)

Li_{z}Mn_{2-c}M³O₄ (4)

(in the formula (4), M³ is at least one metal selected from the group consisting of Na, K, B, F, Al, Ti, V, Cr, Fe, Co, Ni, Cu, Zn, Mg, Ga, Zr, Si, Nb, Mo, Sn and W, and 0.9≤z and 0≤c≤1.5 are satisfied)

Li_{1+w}M⁴_{d}M⁵ₑO₂ (5)

(in the formula (5), each of M⁴ and M⁵ is at least one metal selected from the group consisting of Al, Ti, V, Cr, Mn, Fe, Co, Ni, Cu, Zn, Mg and Ca, and 0<w≤⅓, 0≤d≤⅔, 0≤e≤⅔, and w+d+e=1 are satisfied)

Specific examples of the lithium complex oxides represented by the formulae (2) through (5) include LiCoO₂, LiNiO₂, LiMnO₂, LiNi_{0.8}Co_{0.2}O₂, LiNi_{0.5}Mn_{0.5}O₂, LiNi_{0.85}Co_{0.10}Al_{0.05}O₂, LiNi_{0.8}Co_{0.15}Al_{0.05}O₂, LiNi_{0.5}Co_{0.2}Mn_{0.3}O₂, LiNi_{0.6}Co_{0.2}Mn_{0.2}O₂, LiNi_{0.33}Co_{0.33}Mn_{0.33}O₂, LiMn₂O₄, LiMn_{1.5}Ni_{0.5}O₄, LiMn_{1.5}Fe_{0.5}O₄, LiCoMnO₄, Li_{1.21}Ni_{0.20}Mn_{0.59}O₂, Li_{1.22}Ni_{0.20}Mn_{0.58}O₂, Li_{1.22}Ni_{0.15}Co_{0.10}Mn_{0.53}O₂, Li_{1.07}Ni_{0.35}Co_{0.08}Mn_{0.50}O₂, Li_{1.07}Ni_{0.36}Co_{0.08}Mn_{0.49}O₂, and the like.

Moreover, it is possible to preferably use, as a positive electrode active material, a lithium complex oxide other than the lithium complex oxides represented by the formulae (2) through (5). Examples of such a lithium complex oxide include LiNiVO₄, LiV₃O₆, Li_{1.2}Fe_{0.4}Mn_{0.4}O₂, and the like.

Examples of the material which can be preferably used as a positive electrode active material other than the lithium complex oxide include a phosphate having an olivine-type structure (such as a phosphate having an olivine-type structure represented by a formula (6) below).

Liᵥ(M⁶_{f}M⁷_{g}M⁸ₕM⁹ᵢ)ⱼPO₄ (6)

(in the formula (6), M⁶ is Mn, Co, or Ni, M⁷ is Ti, V, Cr, Mn, Fe, Co, Ni, Zr, Nb, or Mo, M⁸ is a transition metal arbitrarily excluding elements of the group VIA and the group VIIA or a representative element, M⁹ is a transition metal arbitrarily excluding elements of the group VIA and the group VIIA or a representative element, and 1.2≥a≥0.9, 1≥b≥0.6, 0.4≥c≥0, 0.2≥d≥0, 0.2≥e≥0, and 1.2≥f≥0.9 are satisfied)

In the positive electrode active material, each of surfaces of lithium metal complex oxide particles constituting the positive electrode active material is preferably coated with a coating layer. Examples of a material constituting the coating layer include a metal complex oxide, a metal salt, a boron-containing compound, a nitrogen-containing compound, a silicon-containing compound, a sulfur-containing compound, and the like. Among these, the metal complex oxide is suitably employed.

As the metal complex oxide, an oxide having lithium ion conductivity is suitably used. Example of such a metal complex oxide include a metal complex oxide constituted by Li and at least one element selected from the group consisting of Nb, Ge, Si, P, Al, W, Ta, Ti, S, Zr, Zn, V and B. When each of the particles of the positive electrode active material is coated with the coating layer, the coating layer inhibits side reaction at an interface between the positive electrode active material and the electrolyte under high voltage, and this makes it possible to achieve life extension of an obtained secondary battery. Moreover, it is possible to inhibit formation of a high-resistivity layer at the interface between the positive electrode active material and the electrolyte, and this makes it possible to achieve higher output of an obtained secondary battery.

<Nonaqueous Electrolyte>

Examples of the nonaqueous electrolyte include a nonaqueous electrolyte prepared by dissolving a lithium salt in an organic solvent. Examples of the lithium salt include LiClO₄, LiPF₆, LiAsF₆, LiSbF₆, LiBF₄, LiSO₃F, LiCF₃SO₃, LiN(SO₂CF₃)₂, LiN(SO₂C₂F₅)₂, LiN(SO₂CF₃)(COCF₃), Li(C₄FgSO₃), LiC(SO₂CF₃)₃, Li₂BioClio, LiBOB (where BOB is bis(oxalato)borate), lower aliphatic carboxylic acid lithium salt, LiAlCl₄, and the like. These materials can be used alone, or two or more types of these can be used as a mixture. Among those lithium salts, it is preferable to use at least one lithium salt selected from the group consisting of LiPF₆, LiAsF₆, LiSbF₆, LiBF₄, LiSO₃F, LiCF₃SO₃, LiN(SO₂CF₃)₂ and LiC(SO₂CF₃)₃, each of which contains fluorine.

Examples of the organic solvent include carbonates such as propylene carbonate, ethylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and compounds each prepared by introducing a fluoro group into those organic solvents (i.e., compounds each prepared by substituting one or more hydrogen atoms of the organic solvent with fluorine atoms).

As the organic solvent, it is preferable to use two or more of those organic solvents in combination. Among those, it is preferable to employ a mixed solvent containing a carbonate, and it is further preferable to employ a mixed solvent containing a cyclic carbonate and an acyclic carbonate or a mixed solvent containing a cyclic carbonate and an ether. The mixed solvent containing a cyclic carbonate and an acyclic carbonate is preferably a mixed solvent containing ethylene carbonate, dimethyl carbonate, and ethyl methyl carbonate. The nonaqueous electrolyte containing such a mixed solvent has advantages of having a wide range of operating temperatures, being hardly deteriorated even when being used at a high voltage, being hardly deteriorated even when being used for a long period of time, and being hardly decomposed even when a graphite material such as natural graphite or artificial graphite is used as an active material of the negative electrode.

It is preferable to use, as the nonaqueous electrolyte, a nonaqueous electrolyte containing a lithium salt (such as LiPF₆) containing fluorine and an organic solvent including a fluorine substituent group, because such a nonaqueous electrolyte can enhance safety of an obtained nonaqueous electrolyte secondary battery. It is further preferable to use a mixed solvent containing a dimethyl carbonate and an ether (such as pentafluoropropyl methylether or 2,2,3,3-tetrafluoropropyl difluoro methylether) having a fluorine substituent group, because a high capacity maintenance ratio can be achieved even when the obtained nonaqueous electrolyte secondary battery is discharged at a high voltage.

<Negative Electrode>

Examples of the negative electrode include a negative electrode sheet having a structure in which an active material layer containing a negative electrode active material and a binding agent is formed on a current collector. The active material layer may further contain an electrically conductive agent.

<Negative Electrode Active Material>

Examples of the negative electrode active material include carbon materials, chalcogen compounds (such as oxide and sulfide), nitrides, metals, and alloys which can be doped with and dedoped of lithium ions at an electric potential lower than that for the positive electrode.

Examples of the carbon material which can be used as the negative electrode active material include graphites such as natural graphite and artificial graphite, cokes, carbon black, pyrolytic carbons, carbon fiber, and a fired product of an organic polymer compound.

Examples of the oxide which can be used as the negative electrode active material include oxides of silicon represented by a formula SiOₓ (where x is a positive real number) such as SiO₂ and SiO; oxides of titanium represented by a formula TiOₓ (where x is a positive real number) such as TiO₂ and TiO; oxides of vanadium represented by a formula VₓO_{y} (where each of x and y is a positive real number) such as V₂O₅ and VO₂; oxides of iron represented by a formula FeₓO_{y} (where each of x and y is a positive real number) such as Fe₃O₄, Fe₂O₃, and FeO; oxides of tin represented by a formula SnOₓ (where x is a positive real number) such as SnO₂ and SnO; oxides of tungsten represented by a general formula WOₓ (where x is a positive real number) such as WO₃ and WO₂; complex metal oxides (such as Li₄Ti₅O₁₂ and LiVO₂) containing lithium and titanium or vanadium; and the like.

Examples of the sulfide which can be used as the negative electrode active material include sulfides of titanium represented by a formula Ti_{X}S_{y} (where each of x and y is a positive real number) such as Ti₂S₃, TiS₂, and TiS; sulfides of vanadium represented by a formula VSₓ (where x is a positive real number) such as V₃S₄, VS₂, and VS; sulfides of iron represented by a formula FeₓS_{y} (where each of x and y is a positive real number) such as Fe₃S₄, FeS₂, and FeS; sulfides of molybdenum represented by a formula MoₓS_{y} (where each of x and y is a positive real number) such as Mo₂S₃ and MoS₂; sulfides of tin represented by a formula SnSₓ (where x is a positive real number) such as SnS₂ and SnS; sulfides of tungsten represented by a formula WSₓ (where x is a positive real number) such as WS₂; sulfides of antimony represented by a formula SbₓS_{y} (where each of x and y is a positive real number) such as Sb₂S₃; sulfides of selenium represented by a formula SeₓS_{y} (where each of x and y is a positive real number) such as Se₅S₃, SeS₂, and SeS; and the like.

Examples of the nitride which can be used as the negative electrode active material include lithium-containing nitrides such as Li₃N and Li₃₋ₓAₓN (where A is one of or both of Ni and Co, and 0<x<3 is satisfied).

The carbon materials, oxides, sulfides, and nitrides can be used alone, or two or more types of those can be used in combination. The carbon materials, oxides, sulfides, and nitrides can each be a crystalline substance or an amorphous substance. The carbon materials, oxides, sulfides, and nitrides are each mainly supported by a negative electrode current collector so as to be used as an electrode.

Examples of the metal which can be used as the negative electrode active material include a lithium metal, a silicon metal, and a tin metal.

It is possible to employ a complex material which contains Si or Sn as a first constituent element and also contains second and third constituent elements. The second constituent element is, for example, at least one element selected from cobalt, iron, magnesium, titanium, vanadium, chromium, manganese, nickel, copper, zinc, gallium, and zirconium. The third constituent element is, for example, at least one element selected from boron, carbon, aluminum, and phosphorus.

In particular, in order to achieve high battery capacity and excellent battery characteristic, the metal material is preferably a simple substance of silicon or tin (which may contain a slight amount of impurities), SiOᵥ (0<v≤2), SnO_{w} (0≤w≤2), an Si—Co—C complex material, an Si—Ni—C complex material, an Sn—Co—C complex material, or an Sn—Ni—C complex material.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss the present invention in further detail with reference to Examples and Comparative Examples. Note, however, that the present invention is not limited to those Examples.

<Test Method>

(1. Measurement of Total-Light Transmittance)

Each of the compositions prepared in Examples and Comparative Examples was put into a quartz cell having an optical path length of 5 mm, and a total-light transmittance of the composition was measured in conformity to JIS K7361-1: 1997 with use of COH7700 available from NIPPON DENSHOKU INDUSTRIES CO., LTD.

Moreover, a total-light transmittance of each of the nonaqueous electrolyte secondary battery laminated separators prepared in Examples and Comparative Examples was measured in conformity to JIS K7361-1: 1997 with use of COH7700. In this case, the quartz cell was not used. The separator was disposed such that a coated surface made contact with an integrating sphere, and measurement was carried out with use of a C illuminant.

(2. Measurement of Color Difference Between Defective Part and Normal Part)

Each of the nonaqueous electrolyte secondary battery laminated separators prepared in Examples and Comparative Examples was placed on a white backlight. Subsequently, with use of a digital camera (SONY CyberShot (registered trademark) DSC-WX350), an image of a pseudo defect and a normal part around the pseudo defect in the nonaqueous electrolyte secondary battery laminated separator was taken from 30 cm above in conditions of F=3.5, ISO 80, and 1/250. The pseudo defect is a part including gas bubbles which occurred when the base material was coated with each of the compositions prepared in Examples and Comparative Examples for preparing the nonaqueous electrolyte secondary battery laminated separator.

RGB values of one pseudo defect and one normal part in the image were obtained with use of the dropper tool of Microsoft (registered trademark) Paint, and a color difference between the pseudo defect and the normal part was calculated according to a formula below. The number of combinations of a pseudo defect and a normal part for which RGB values were obtained was three in total, and an average of obtained color differences was calculated.

Color difference=\sqrt{(R₁−R₂)²+(G₁−G₂)²+(B₁−B₂)²}

In the formula, R₁, G₁, and B₁ refer to an R value, a G value, and a B value, respectively, of the normal part. Moreover, R₂, G₂, and B₂ refer to an R value, a G value, and a B value, respectively, of the pseudo defect.

### Example 1

(1. Preparation of Composition)

A 500-mL separable flask having a stirring blade, a thermometer, a nitrogen incurrent canal, and a powder addition port was used. Nitrogen was introduced into the flask to thoroughly dry the flask. Then, 409.2 g of N-methyl-2-pyrrolidone (hereinafter abbreviated as “NMP”) as an organic solvent was put into the flask. In addition, 30.8 g of calcium chloride was added as chloride (for 2 hours at 200° C., using vacuum drying), and a temperature was raised to 100° C. to completely dissolve the calcium chloride. Then, a temperature of the obtained solution was returned to room temperature (25° C.), and a water content of the solution was adjusted to 500 ppm.

Next, 7.44 g of 2-chloroparaphenylenediamine as an aromatic diamine was added and completely dissolved. While stirring this solution while keeping the temperature at 20±2° C., 10.29 g of dichloride terephthalate (hereinafter abbreviated as “TPC”) as an aromatic dicarboxylic acid was added.

Through the method, an aramid resin 1 having the following properties was obtained: a chloro group was contained as an electron-withdrawing group in each of aromatic rings in a main chain; amino groups were contained at both ends of a molecule; 100% of bonds connecting the aromatic rings in the main chain were amide bonds; 100% of aromatic diamine-derived units had electron-withdrawing groups; acid chloride-derived units had no electron-withdrawing groups; and an intrinsic viscosity was 1.5 dL/g. Both ends of a molecule of the aramid resin 1 were phenylamine having a chloro group.

Subsequently, the aramid resin 1, alumina having a larger particle size and alumina having a smaller particle size as a filler, and N-methyl-6-pyrolidone (NMP) as a solvent were mixed together to prepare a composition 1 in which a total concentration of the aramid resin 1 and the filler was 6% by weight. In this case, in order that a content of the filler in a porous layer described later became 66% by weight, the aramid resin 1, the filler, and the solvent were mixed while setting a content of the filler to be 66% by weight, where a weight of the aramid resin 1 and the filler was 100% by weight.

(2. Preparation of Nonaqueous Electrolyte Secondary Battery Laminated Separator)

One surface of a porous film, which had been obtained by stretching a polyolefin resin composition constituted by ultra-high molecular weight polyethylene, was coated with the composition 1 at a coating speed of 1.2 m/min with use of a G-7 type bar coater available from TECHNO SUPPLY Co. LTD while setting a fixed clearance of a Baker's applicator at 2 mil. Subsequently, the aramid resin 1 was precipitated under an environment having a temperature of 50° C. and humidity of 70% and was then cleaned with water and dried. Thus, a nonaqueous electrolyte secondary battery laminated separator 1 was obtained in which a porous layer was formed on a surface of the base material. In this case, it was confirmed, by thermogravimetric analysis (TGA), that 99% or more of the solvent was removed from the composition.

(3. Measurement of Total-Light Transmittance, and Measurement of Color Difference)

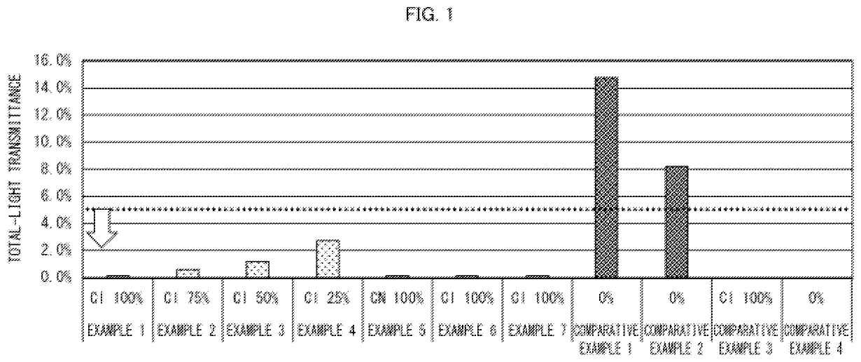

On the basis of <Test method> above, a total-light transmittance of the composition 1 was measured, and a color difference was measured with use of the nonaqueous electrolyte secondary battery laminated separator 1. The results are shown in Table 1, Table 2, and FIGS. 1 through 3.

### Example 2

(1. Preparation of Composition)

An aramid resin was prepared by a process similar to that of Example 1, except that an added amount of 2-chloro-1,4-phenylenediamine as aromatic diamine was set to 5.60 g, an added amount of paraphenylenediamine as aromatic diamine was set to 1.42 g, and an added amount of TPC as aromatic dicarboxylic acid was set to 10.54 g. Thus, an aramid resin 2 having the following properties was obtained: a chloro group was contained as an electron-withdrawing group in each of aromatic rings in a main chain; amino groups were contained at both ends of a molecule; 100% of bonds connecting the aromatic rings in the main chain were amide bonds; 75% of aromatic diamine-derived units had electron-withdrawing groups; acid chloride-derived units had no electron-withdrawing groups; and an intrinsic viscosity was 1.6 dL/g.

Subsequently, the aramid resin 2, alumina having a larger particle size and alumina having a smaller particle size as a filler, and NMP as a solvent were mixed together to prepare a composition 2 in which a total concentration of the aramid resin 2 and the filler was 4% by weight. In this case, in order that a content of the filler in a porous layer described later became 66% by weight, the aramid resin 2, the filler, and the solvent were mixed while setting a content of the filler to be 66% by weight, where a weight of the aramid resin 2 and the filler was 100% by weight.

(2. Preparation of Nonaqueous Electrolyte Secondary Battery Laminated Separator, Measurement of Total-Light Transmittance, and Measurement of Color Difference)

A nonaqueous electrolyte secondary battery laminated separator 2 was obtained by a process similar to that of Example 1, except that the composition 2 was used instead of the composition 1. On the basis of <Test method> above, a total-light transmittance of the composition 2 was measured, and a color difference was measured with use of the nonaqueous electrolyte secondary battery laminated separator 2. The results are shown in Table 1, Table 2, and FIGS. 1 through 3.

### Example 3

(1. Preparation of Composition)

An aramid resin was prepared by a process similar to that of Example 1, except that an added amount of 2-chloro-1,4-phenylenediamine as aromatic diamine was set to 3.73 g, an added amount of paraphenylenediamine as aromatic diamine was set to 2.83 g, and an added amount of TPC as aromatic dicarboxylic acid was set to 10.54 g. Thus, an aramid resin 3 having the following properties was obtained: a chloro group was contained as an electron-withdrawing group in each of aromatic rings in a main chain; amino groups were contained at both ends of a molecule; 100% of bonds connecting the aromatic rings in the main chain were amide bonds; 50% of aromatic diamine-derived units had electron-withdrawing groups; acid chloride-derived units had no electron-withdrawing groups; and an intrinsic viscosity was 1.1 dL/g.

Subsequently, the aramid resin 3, alumina having a larger particle size and alumina having a smaller particle size as a filler, and NMP as a solvent were mixed together to prepare a composition 3 in which a total concentration of the aramid resin 3 and the filler was 4% by weight. In this case, in order that a content of the filler in a porous layer described later became 66% by weight, the aramid resin 3, the filler, and the solvent were mixed while setting a content of the filler to be 66% by weight, where a weight of the aramid resin 3 and the filler was 100% by weight.

(2. Preparation of Nonaqueous Electrolyte Secondary Battery Laminated Separator, Measurement of Total-Light Transmittance, and Measurement of Color Difference)

A nonaqueous electrolyte secondary battery laminated separator 3 was obtained by a process similar to that of Example 1, except that the composition 3 was used instead of the composition 1. On the basis of <Test method> above, a total-light transmittance of the composition 3 was measured, and a color difference was measured with use of the nonaqueous electrolyte secondary battery laminated separator 3. The results are shown in Table 1, Table 2, and FIGS. 1 through 3.

### Example 4

(1. Preparation of Composition)

An aramid resin was prepared by a process similar to that of Example 1, except that an added amount of 2-chloro-1,4-phenylenediamine as aromatic diamine was set to 1.87 g, an added amount of paraphenylenediamine as aromatic diamine was set to 4.25 g, and an added amount of TPC as aromatic dicarboxylic acid was set to 10.54 g. Thus, an aramid resin 4 having the following properties was obtained: a chloro group was contained as an electron-withdrawing group in each of aromatic rings in a main chain; amino groups were contained at both ends of a molecule; 100% of bonds connecting the aromatic rings in the main chain were amide bonds; 25% of aromatic diamine-derived units had electron-withdrawing groups; acid chloride-derived units had no electron-withdrawing groups; and an intrinsic viscosity was 0.8 dL/g.

Subsequently, the aramid resin 4, alumina having a larger particle size and alumina having a smaller particle size as a filler, and NMP as a solvent were mixed together to prepare a composition 4 in which a total concentration of the aramid resin 4 and the filler was 4% by weight. In this case, in order that a content of the filler in a porous layer described later became 66% by weight, the aramid resin 4, the filler, and the solvent were mixed while setting a content of the filler to be 66% by weight, where a weight of the aramid resin 4 and the filler was 100% by weight.

(2. Preparation of Nonaqueous Electrolyte Secondary Battery Laminated Separator, Measurement of Total-Light Transmittance, and Measurement of Color Difference)

A nonaqueous electrolyte secondary battery laminated separator 4 was obtained by a process similar to that of Example 1, except that the composition 4 was used instead of the composition 1. On the basis of <Test method> above, a total-light transmittance of the composition 4 was measured, and a color difference was measured with use of the nonaqueous electrolyte secondary battery laminated separator 4. The results are shown in Table 1, Table 2, and FIGS. 1 through 3.

### Example 5

(1. Preparation of Composition)

An aramid resin was prepared by a process similar to that of Example 1, except that an added amount of 2-cyano-1,4-phenylenediamine as aromatic diamine was set to 5.40 g, and an added amount of TPC as aromatic dicarboxylic acid was set to 8.16 g. Thus, an aramid resin 5 having the following properties was obtained: a cyano group was contained as an electron-withdrawing group in each of aromatic rings in a main chain; amino groups were contained at both ends of a molecule; 100% of bonds connecting the aromatic rings in the main chain were amide bonds; 100% of aromatic diamine-derived units had electron-withdrawing groups; acid chloride-derived units had no electron-withdrawing groups; and an intrinsic viscosity was 2.6 dL/g. Both ends of a molecule of the aramid resin 5 were phenylamine having a cyano group.

Subsequently, the aramid resin 5, alumina having a larger particle size and alumina having a smaller particle size as a filler, and NMP as a solvent were mixed together to prepare a composition 5 in which a total concentration of the aramid resin 5 and the filler was 4% by weight. In this case, in order that a content of the filler in a porous layer described later became 66% by weight, the aramid resin 5, the filler, and the solvent were mixed while setting a content of the filler to be 66% by weight, where a weight of the aramid resin 5 and the filler was 100% by weight.

(2. Preparation of Nonaqueous Electrolyte Secondary Battery Laminated Separator, Measurement of Total-Light Transmittance, and Measurement of Color Difference)

A nonaqueous electrolyte secondary battery laminated separator 5 was obtained by a process similar to that of Example 1, except that the composition 5 was used instead of the composition 1. On the basis of <Test method> above, a total-light transmittance of the composition 5 was measured, and a color difference was measured with use of the nonaqueous electrolyte secondary battery laminated separator 5. The results are shown in Table 1, Table 2, and FIGS. 1 through 3.

### Example 6

(1. Preparation of Coating Solution)

An aramid resin was prepared by a process similar to that of Example 1, except that an added amount of 2-chloro-1,4-phenylenediamine as aromatic diamine was set to 8.63 g, and an added amount of TPC as acid chloride was set to 11.96 g. Thus, an aramid resin 6 having the following properties was obtained: a chloro group was contained as an electron-withdrawing group in each of aromatic rings in a main chain; amino groups were contained at both ends of a molecule; 100% of bonds connecting the aromatic rings in the main chain were amide bonds; 100% of aromatic diamine-derived units had electron-withdrawing groups; acid chloride-derived units had no electron-withdrawing groups; and an intrinsic viscosity was 1.9 dL/g.

Subsequently, the aramid resin 6, alumina having a larger particle size and alumina having a smaller particle size as a filler, and NMP as a solvent were mixed together to prepare a composition 6 in which a total concentration of the aramid resin 6 and the filler was 4% by weight. In this case, in order that a content of the filler in a porous layer described later became 40% by weight, the aramid resin 6, the filler, and the solvent were mixed while setting a content of the filler to be 40% by weight, where a weight of the aramid resin 6 and the filler was 100% by weight.

(2. Preparation of Nonaqueous Electrolyte Secondary Battery Laminated Separator, Measurement of Total-Light Transmittance, and Measurement of Color Difference)

A nonaqueous electrolyte secondary battery laminated separator 6 was obtained by a process similar to that of Example 1, except that the composition 6 was used instead of the composition 1. On the basis of <Test method> above, a total-light transmittance of the composition 6 was measured, and a color difference was measured with use of the nonaqueous electrolyte secondary battery laminated separator 6. The results are shown in Table 1, Table 2, and FIGS. 1 through 3.

### Example 7

(1. Preparation of Coating Solution)

An aramid resin was prepared by a process similar to that of Example 1, except that an added amount of 2-chloro-1,4-phenylenediamine as aromatic diamine was set to 8.63 g, and an added amount of TPC as acid chloride was set to 11.96 g. Thus, an aramid resin 7 having the following properties was obtained: a chloro group was contained as an electron-withdrawing group in each of aromatic rings in a main chain; amino groups were contained at both ends of a molecule; 100% of bonds connecting the aromatic rings in the main chain were amide bonds; 100% of aromatic diamine-derived units had electron-withdrawing groups; acid chloride-derived units had no electron-withdrawing groups; and an intrinsic viscosity was 1.9 dL/g.

Subsequently, the aramid resin 7, alumina having a larger particle size and alumina having a smaller particle size as a filler, and NMP as a solvent were mixed together to prepare a composition 7 in which a total concentration of the aramid resin 7 and the filler was 3% by weight. In this case, in order that a content of the filler in a porous layer described later became 20% by weight, the aramid resin 7, the filler, and the solvent were mixed while setting a content of the filler to be 20% by weight, where a weight of the aramid resin 7 and the filler was 100% by weight.

(2. Preparation of Nonaqueous Electrolyte Secondary Battery Laminated Separator, Measurement of Total-Light Transmittance, and Measurement of Color Difference)

A nonaqueous electrolyte secondary battery laminated separator 7 was obtained by a process similar to that of Example 1, except that the composition 7 was used instead of the composition 1. On the basis of <Test method> above, a total-light transmittance of the composition 7 was measured, and a color difference was measured with use of the nonaqueous electrolyte secondary battery laminated separator 7. The results are shown in Table 1, Table 2, and FIGS. 1 through 3.

### Comparative Example 1

(1. Preparation of Composition)

An aramid resin was prepared by a process similar to that of Example 1, except that an added amount of paraphenylenediamine as aromatic diamine was set to 13.20 g, and an added amount of TPC as aromatic dicarboxylic acid was set to 24.18 g. Thus, a comparative aramid resin 1 was obtained which had the following properties: no electron-withdrawing group was contained in each of aromatic rings in a main chain; amino groups were contained at both ends of a molecule; 100% of bonds connecting the aromatic rings in the main chain were amide bonds; aromatic diamine-derived units and acid chloride-derived units had no electron-withdrawing groups; and an intrinsic viscosity was 1.9 dL/g.

Subsequently, the comparative aramid resin 1, alumina having a larger particle size and alumina having a smaller particle size as a filler, and NMP as a solvent were mixed together to prepare a comparative composition 1. In this case, in order that a content of the filler in a porous layer described later became 66% by weight, the comparative aramid resin 1, the filler, and the solvent were mixed while setting a content of the filler to be 66% by weight, where a weight of the comparative aramid resin 1 and the filler was 100% by weight.

(2. Preparation of Nonaqueous Electrolyte Secondary Battery Laminated Separator, Measurement of Total-Light Transmittance, and Measurement of Color Difference)

A comparative nonaqueous electrolyte secondary battery laminated separator 1 was obtained by a process similar to that of Example 1, except that the comparative composition 1 was used instead of the composition 1. On the basis of <Test method> above, a total-light transmittance of the comparative composition 1 was measured, and a color difference was measured with use of the comparative nonaqueous electrolyte secondary battery laminated separator 1. The results are shown in Table 1, Table 2, and FIGS. 1 through 3.

### Comparative Example 2

(1. Preparation of Composition)

The comparative aramid resin 1, alumina having a smaller particle size as a filler, and NMP as a solvent were mixed together to prepare a comparative composition 2 in which a total concentration of the comparative aramid resin 1 and the filler was 4% by weight. In this case, in order that a content of the filler in a porous layer described later became 50% by weight, the comparative aramid resin 1, the filler, and the solvent were mixed while setting a content of the filler to be 50% by weight, where a weight of the comparative aramid resin 1 and the filler was 100% by weight.

(2. Preparation of Nonaqueous Electrolyte Secondary Battery Laminated Separator, Measurement of Total-Light Transmittance, and Measurement of Color Difference)

A comparative nonaqueous electrolyte secondary battery laminated separator 2 was obtained by a process similar to that of Example 1, except that the comparative composition 2 was used instead of the composition 1. On the basis of <Test method> above, a total-light transmittance of the comparative composition 2 was measured, and a color difference was measured with use of the comparative nonaqueous electrolyte secondary battery laminated separator 2. The results are shown in Table 1, Table 2, and FIGS. 1 through 3.

### Comparative Example 3

(1. Preparation of Coating Solution)

An aramid resin was prepared by a process similar to that of Example 1, except that an added amount of 2-chloro-1,4-phenylenediamine as aromatic diamine was set to 11.20 g, and an added amount of 4,4′-oxybis(benzoyl chloride) as acid chloride was set to 10.51 g. Thus, a comparative aramid resin 3 having the following properties was obtained: a chloro group was contained as an electron-withdrawing group in each of aromatic rings in a main chain; amino groups were contained at both ends of a molecule; 66% of bonds connecting the aromatic rings in the main chain were amide bonds; 100% of aromatic diamine-derived units had electron-withdrawing groups; acid chloride-derived units had no electron-withdrawing groups; and an intrinsic viscosity was 1.5 dL/g.

Subsequently, the comparative aramid resin 3, alumina having a larger particle size and alumina having a smaller particle size as a filler, and NMP as a solvent were mixed together to prepare a comparative composition 3 in which a total concentration of the comparative aramid resin 3 and the filler was 6% by weight. In this case, in order that a content of the filler in a porous layer described later became 50% by weight, the comparative aramid resin 3, the filler, and the solvent were mixed while setting a content of the filler to be 50% by weight, where a weight of the comparative aramid resin 3 and the filler was 100% by weight.

(2. Preparation of Nonaqueous Electrolyte Secondary Battery Laminated Separator, Measurement of Total-Light Transmittance, and Measurement of Color Difference)

A comparative nonaqueous electrolyte secondary battery laminated separator 3 was obtained by a process similar to that of Example 1, except that the comparative composition 3 was used instead of the composition 1. On the basis of <Test method> above, a total-light transmittance of the comparative composition 3 was measured, and a color difference was measured with use of the comparative nonaqueous electrolyte secondary battery laminated separator 3. The results are shown in Table 1, Table 2, and FIGS. 1 through 3.

### Comparative Example 4

(1. Preparation of Coating Solution)

An aramid resin was prepared by a process similar to that of Example 1, except that an added amount of 4,4′-diaminodiphenyl ether as aromatic diamine was set to 17.31 g, and an added amount of TPC as acid chloride was set to 17.38 g. Thus, a comparative aramid resin 4 having the following properties was obtained: no electron-withdrawing group was contained in each of aromatic rings in a main chain; amino groups were contained at both ends of a molecule; 66% of bonds connecting the aromatic rings in the main chain were amide bonds; aromatic diamine-derived units had no electron-withdrawing groups; acid chloride-derived units had no electron-withdrawing groups; and an intrinsic viscosity was 1.7 dL/g.

Subsequently, the comparative aramid resin 4, alumina having a larger particle size and alumina having a smaller particle size as a filler, and NMP as a solvent were mixed together to prepare a comparative composition 4 in which a total concentration of the comparative aramid resin 4 and the filler was 6% by weight. In this case, in order that a content of the filler in a porous layer described later became 50% by weight, the comparative aramid resin 4, the filler, and the solvent were mixed while setting a content of the filler to be 50% by weight, where a weight of the comparative aramid resin 4 and the filler was 100% by weight.

(2. Preparation of Nonaqueous Electrolyte Secondary Battery Laminated Separator, Measurement of Total-Light Transmittance, and Measurement of Color Difference)

A comparative nonaqueous electrolyte secondary battery laminated separator 4 was obtained by a process similar to that of Example 1, except that the comparative composition 4 was used instead of the composition 1. On the basis of <Test method> above, a total-light transmittance of the comparative composition 4 was measured, and a color difference was measured with use of the comparative nonaqueous electrolyte secondary battery laminated separator 4. The results are shown in Table 1, Table 2, and FIGS. 1 through 3.

TABLE 1

| | Electron- | | | | Ratio of | | |
|---|---|---|---|---|---|---|---|
| | withdrawing | Withdrawing | Withdrawing | | amide | | |
| | group in | group | group | Presence or | groups | Filler content | Aramid |
| | aromatic | content in | content in | absence of | connecting | in porous | intrinsic |
| | ring in main | diamine unit | acid chloride | end amino | aromatic | layer (% by | viscosity |
| | chain | (%) | unit (%) | group | rings (%) | mass) | (dL/g) |
| Example 1 | Cl | 100 | 0 | ○ | 100 | 66 | 1.5 |
| Example 2 | Cl | 75 | 0 | ○ | 100 | 66 | 1.6 |
| Example 3 | Cl | 50 | 0 | ○ | 100 | 66 | 1.1 |
| Example 4 | Cl | 25 | 0 | ○ | 100 | 66 | 0.8 |
| Example 5 | CN | 100 | 0 | ○ | 100 | 66 | 2.6 |
| Example 6 | Cl | 100 | 0 | ○ | 100 | 40 | 2.6 |
| Example 7 | Cl | 100 | 0 | ○ | 100 | 20 | 1.9 |
| Comparative | None | 0 | 0 | ○ | 100 | 66 | 1.9 |
| Example 1 | | | | | | | |
| Comparative | None | 0 | 0 | ○ | 100 | 50 | 1.9 |
| Example 2 | | | | | | | |
| Comparative | Cl | 100 | 0 | ○ | 66 | 50 | 1.5 |
| Example 3 | | | | | | | |
| Comparative | None | 0 | 0 | ○ | 66 | 50 | 1.7 |
| Example 4 | | | | | | | |

TABLE 2

| | | Total-light | Color difference |
|---|---|---|---|
| | Total-light | transmittance of | between defective |
| | transmittance of | laminated separator | part and normal part |
| | composition (%) | (%) | (RGB) |
| Example 1 | 0.1 | 18.3 | 76.4 |
| Example 2 | 0.6 | 21.6 | 48.2 |
| Example 3 | 1.2 | 25.2 | 34.2 |
| Example 4 | 2.7 | 29.5 | 33.2 |
| Example 5 | 0.1 | 19.9 | 74.6 |
| Example 6 | 0.1 | 23.9 | 51.1 |
| Example 7 | 0.1 | 24.7 | 27.6 |
| Comparative | 14.8 | 33.7 | 10.5 |
| Example 1 | | | |
| Comparative | 8.2 | 36.7 | 15.2 |
| Example 2 | | | |
| Comparative | — | 30.3 | 19.6 |
| Example 3 | | | |
| Comparative | — | 34.4 | 4.0 |
| Example 4 | | | |

In Table 1: “Electron-withdrawing group in aromatic ring in main chain” refers to a type of electron-withdrawing group contained in an aromatic ring in a main chain; “Withdrawing group content in diamine unit” refers to a ratio of aromatic diamine-derived units which have electron-withdrawing groups in the aramid resin; “Withdrawing group content in acid chloride unit” refers to a ratio of acid chloride-derived units which have electron-withdrawing groups in the aramid resin; “Presence or absence of end amino group” indicates whether or not a molecule end of the aramid resin has an amino group (where the symbol “o” indicates a case of presence); “Ratio of amide groups connecting aromatic rings” refers to a ratio of bonds with which aromatic rings in the main chain are connected to each other and which have amide groups; “Filler content in porous layer” refers to a filler content relative to 100% by weight of the porous layer; and “Aramid intrinsic viscosity” refers to an intrinsic viscosity of the aramid resin.

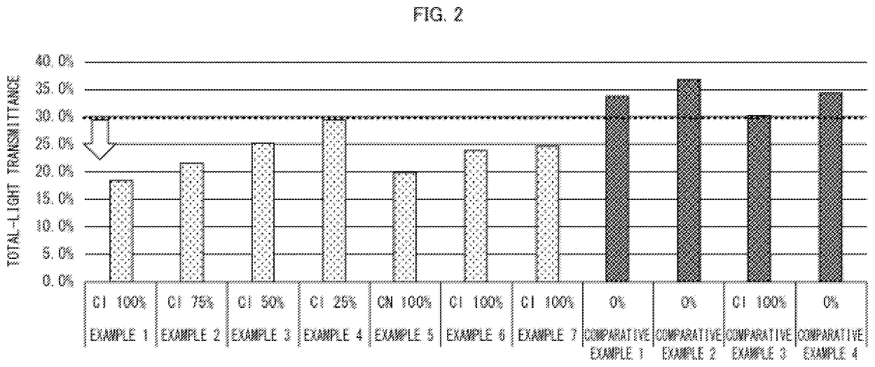

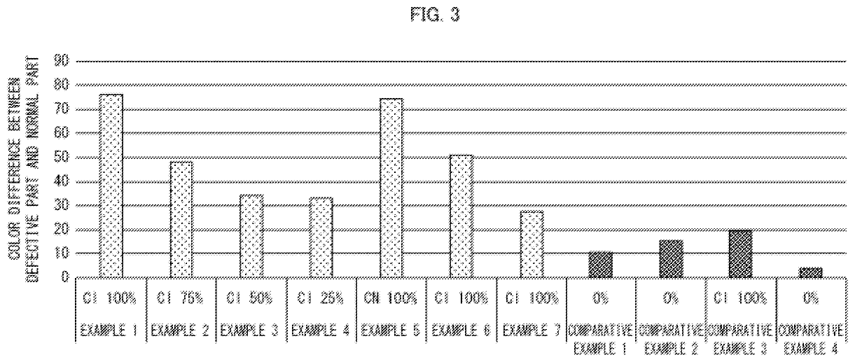

FIG. 1 is a diagram showing a graph of “Total-light transmittance of composition” in Table 2; FIG. 2 is a diagram showing a graph of “Total-light transmittance of laminated separator” in Table 2, and FIG. 3 is a diagram showing a graph of “Color difference between defective part and normal part” in Table 2. The dotted lines in FIG. 1 and FIG. 2 indicate that total-light transmittances below the values on the respective dotted lines are preferable because presence or absence of defects in a nonaqueous electrolyte secondary battery laminated separator can be easily checked.

As shown in Tables 1 and 2 and FIGS. 1 and 2, the compositions 1 through 7 prepared in Examples have extremely low total-light transmittances, and accordingly total-light transmittances of the nonaqueous electrolyte secondary battery laminated separators 1 through 7 which have been produced using the respective compositions are also low. Therefore, as shown in Table 2 and FIG. 3, each of the nonaqueous electrolyte secondary battery laminated separators 1 through 7 has a greater color difference between the defective part (i.e., the pseudo defect in each of Examples and Comparative Examples) and the normal part. That is, presence of a defect can be easily detected.

### INDUSTRIAL APPLICABILITY

The composition and the like in accordance with an embodiment of the present invention can be suitably used in various industries that deal with nonaqueous electrolyte secondary batteries.

1. A composition comprising:
a solvent; and
an aramid resin in which (i) each of aromatic rings in a main chain has an electron-withdrawing group, (ii) at least one end of a molecule is an amino group, and (iii) more than 90% of bonds with which the aromatic rings in the main chain are connected to each other are amide bonds.

2. The composition as set forth in claim 1, wherein:
in the aramid resin, (iv) 25% or more of aromatic diamine-derived units have electron-withdrawing groups, and (v) 50% or less of acid chloride-derived units have electron-withdrawing groups.

3. The composition as set forth in claim 1, wherein the electron-withdrawing group is one or more groups selected from the group consisting of halogen, a cyano group, and a nitro group.

4. The composition as set forth in claim 1, wherein the aramid resin has an intrinsic viscosity of 0.5 dL/g to 4.0 dL/g.

5. The composition as set forth in claim 1, further comprising a filler.

6. The composition as set forth in claim 1, which has a total-light transmittance of 5% or less, the total-light transmittance being measured in conformity to JIS K7361-1: 1997 in a quartz cell having an optical path length of 5 mm.

7. A laminated body, wherein a composition recited in claim 1 is formed on one surface or both surfaces of a polyolefin porous film.

8. A method for producing a nonaqueous electrolyte secondary battery laminated separator, said method comprising the steps of:
forming a composition recited in claim 1 on one surface or both surfaces of a polyolefin porous film; and
removing 99% or more of the solvent from the composition.

9. A nonaqueous electrolyte secondary battery laminated separator, comprising:
a polyolefin porous film; and
a porous layer which is constituted by a binder resin and a filler and is formed on the polyolefin porous film,
said nonaqueous electrolyte secondary battery laminated separator having a total-light transmittance of 30% or less, the total-light transmittance being measured in conformity to JIS K7361-1: 1997.

10. The nonaqueous electrolyte secondary battery laminated separator as set forth in claim 9, wherein:
the binder resin is an aramid resin in which (i) each of aromatic rings in a main chain has an electron-withdrawing group, (ii) at least one end of a molecule is an amino group, and (iii) more than 90% of bonds with which the aromatic rings in the main chain are connected to each other are amide bonds.
